(19) United States
(12) Patent Application Publication
(10) Pub. No.: US 2006/0115788 A1
(43) Pub. Date: Jun. 1, 2006

(54) Dental hand instrument comprising components which can be displaced in relation to each other

(76) Inventor: Thomas Bierbaum, Bensheim (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/539,004

(22) PCT Filed: Dec. 16, 2003
(86) PCT No.: PCT/DE03/04146

§ 371 Date: Jun. 15, 2005

(30) Foreign Application Priority Data
Dec. 16, 2002 (DE) 102 59 012.5

(51) Int. Cl. A61C 1/18

(52) U.S. Cl. 433/104

(57) ABSTRACT

The invention relates to a dental hand instrument comprising components which can be displaced in relation to each other. Said components are in contact with each other on the surface. Said dental hand instrument also comprises a lubricant for lubricating said components. At least one of the components comprises, on at least part of the surface, a coating containing a lubricant.

### TECHNICAL FIELD

The invention relates to a hand instrument according to the generic term of claim 1 which serves to improve the results of activity during medical treatment by preventing the release of lubricant and its transfer into the work area while ensuring reliability of operation.

### PRIOR ART

Generally, dental hand instruments are oiled at defined intervals in order to lubricate the moving parts. DE 19 65 25 35 A1 and DE 19 65 25 34 A1 describe a dental hand instrument in which the friction of its moving parts is reduced by means of active delivery means using lubricants that are provided in reservoirs, or in which the lubricant is automatically distributed by surface tension or capillary forces.

The drawback here is that the lubricant used can get into the operating area of the drill and thus into the cavity being treated in the patient's mouth via, for example, the bearings and the drill mounting means. If even the smallest amounts of lubricant get into a tooth cavity, the filling placed in the cavity can no longer produce satisfactory results, as the adhesion thereof in the cavity is reduced, among other reasons.

However, according to the prior art, repeated oiling of the instruments is absolutely necessary. Experience has shown that this is normally done irregularly and then often with an excess of oil, which adversely affects the operating behavior and the useful life while also adversely affecting the quality of work due to oil leakage during operation with the formation of oil drops or oil mist.

DE 196 12 571 A1 describes a cageless antifriction bearing for a dental drill in which there are disposed between ceramic rolling elements single rolling elements of plastics material which are soaked in lubricant, deliver lubricant, and/or consist of self-lubricating material. PTFE is proposed as material for the plastics rolling elements. The drawback here is that the rolling element, when used in a dental instrument as described, is itself a non-bearing part whose bearing function must be taken over by the other rolling elements. It is thus an additional component with no inherent guiding characteristics and having no substantial power-transmitting effect on the bearing itself, particularly when said rolling element has itself undergone a certain amount of wear. Furthermore, it is not known whether such bearings are in fact used in the given speed range.

WO 99/14512 describes an antifriction bearing provided with a coating of diamond-like carbon mixed with carbide-forming metal atoms. This coating is suitable for utilization in antifriction bearings that work under dry conditions or where lubrication is poor or completely absent, since the coating does not flake or peel, neither inherently nor off the carrier. Furthermore, a metallic intermediate layer, for instance a chromium layer, can be provided, and tungsten can be used as the metal carbide-forming element. Due to the special wear resistance thereof, there is not provided any substitute for poor lubrication or for the absence of lubrication.

Techniques for coating such components are known from the discipline of coating technology. A component that has been coated by such a technique and a coated or uncoated counterpart are moved relatively to one another in a dry run, thereby transferring material from the coated component onto the uncoated counterpart due to motion thereof, etc. accompanied by smoothing of the two antifriction surfaces.

The object of the invention is to provide a dental hand instrument in which the moving components contained therein can be driven at the customary high speeds with a minimal amount of waste heat and with a high degree of running smoothness, without the risk of oil escaping, and without shortening the useful life as obtained hitherto, while at the same time the aforementioned drawbacks of the prior art are avoided.

### DESCRIPTION OF THE INVENTION

This object is achieved according to the invention as defined in claim 1. Advantageous developments are defined in the subclaims.

Due to the features described in claim 1, according to which at least one of the parts is coated with a lubricant at least over part of its surface, a hand instrument is provided which operates without the necessity of added lubricant.

“Lubricating material” herein encompasses all materials that produce a lubricating effect, without discrimination. Such effects include, inter alia, wear-reducing and/or friction-reducing effects and/or influencing the surface characteristics in a specific manner.

“Lubricant” herein means lubricating materials which are not bound in a solid, such as oils or greases, for example.

“Lubricating substance” herein means lubricating materials that are bound in a solid. These lubricating substances may themselves release lubricating substances.

The coating itself, which is permanently bonded to the substrate or comprises at least one intermediate layer, eg as a carrier layer, can also be regarded as a lubricating substance. In that case, the coating imparts properties to the moving parts which are similar in effect to those of a lubricating material. Thus the coating has an antifriction action.

In the case of a coating that releases a lubricating substance, the amount delivered should be so small that the result of the action done will not be adversely affected even if there is partial atomization or pulverization. The advantage here is that the lubricant is present only at locations where friction processes occur.

Particularly suitable parts include groups of antifriction bearings or plain bearings and/or gear parts and/or toothed wheels and/or shafts and/or couplings.

The use of oil as lubricant can be obviated by such solid lubrication, so that an oil-free concept can be realized for the entire hand instrument system.

Generally, lubricating material is needed wherever friction or abrasion must be reduced and/or surface characteristics must be specifically adjusted. The operator no longer needs to lubricate the hand instrument of the invention periodically, and maintenance errors can be prevented. Furthermore, internal and external contamination of the instruments by lubricant is prevented. As to the procedure itself, advantage is gained in that no lubricant can escape from the instrument, and therefore no lubricant reaches the cavity in the patient's mouth during treatment. This concept relates to hand instruments which are pneumatically driven as well as hand instruments driven by a motor, especially an electromotor.

The matter of gaining knowledge on the behavior of the smallest components under the specific loads occurring in the hand instrument has represented a particularly difficult obstacle to overcome. The experience that has been gained with respect to the behavior of coatings as they are presently studied in a traditional mechanical engineering context, particularly in the material-testing and coating technology sectors, cannot be directly transferred as is to increasingly smaller components, owing to physical and metallurgical effects. Rather, with increasing miniaturization, the influence of stresses based, for example on static loads, diminishes, and the influence of, say, tolerances, surface finish, crystal structures, microstructures, metallurgical diffusion processes, etc, increases.

To that must be added the loads typical of dental hand instruments, such as rotational speeds of from 667 rps (40,000 rpm) to over 6,667 rps (400,000 rpm) depending on the application, which can be achieved via a number of gear stages giving a total transmission ratio in the order of 1:5, in addition to which an optimally high degree of running smoothness and low heat development are required, whilst the capability of sterilization must be maintained.

It is sufficient for only one component to have a coating as long as lubrication occurs by means of the lubricating substance provided in the coating, in which case the lubricating substance can remain on the coating without being transferred onto the uncoated part.

According to a first development, when coating material, and along with the coating material, the lubricating substance that is bound therein, are transferred from the coated component onto the uncoated component due to engagement of said two components, there is the advantage that components already coated during production can be installed in combination with uncoated components. After the initial break-in phase, the engaging surfaces behave like surfaces that were coated from the outset.

When there is a plurality of groups of parts that move relatively to one another and require lubrication, it is advantageous when a coating that transfers lubricating substance is applied to at least one of the parts in every group, it being possible to provide different coatings for different groups. In that case it is not really necessary to coat all of the moving components as long as it is certain that, at locations where said relative movement during a sliding or rolling operation occurs, sufficient lubrication will be provided either on account of the coating present on only one of the engaging components or due to transfer of material caused, eg, by erosional processes.

When the bound lubricating substance and the uncoated countersurface are such that the lubricating substance adheres to the countersurface, the material transfer from the coated part to the initially uncoated part enables smoothing of the two surfaces, thus reducing the operating temperature and increasing the running smoothness.

Another advantage is gained when the composition of the coating varies from its side adjacent the component to be coated toward its exposed surface. By this means it is possible to adjust various functions, such as the adhesion of the coating to the substrate and its abrasion resistance with respect to the part moved relatively thereto. Furthermore, the coating is independent of the geometry of the coated object.

When the proportion of lubricating substance is larger on the exposed surface of the coating than on the side adjacent the component to be coated, this gives rise to the advantage that the mating component has a better supply of lubricant.

The development in which the coating comprises at least one carrier layer which is bonded to the surface of the coated part and at least one lubricating substance layer has the advantage that the adhesion of the coating to the part that bears the coating can be specifically adjusted.

When the lubricating substance in the coating is a solid lubricating substance, there is the assurance that no components thereof which might cause contamination are released when the instrument is not in operation.

When the components embedded in the coating can assume a liquid state during operation, there is the assurance that lubrication will advantageously only occur during operation and only locally.

When the coating comprises a metal-doped, diamond-like carbon (DLC) layer, abrasion resistance is ensured while excellent lubrication is guaranteed.

When the coating comprises one or more polymer layers, a wide range of applications is possible, given the extremely high potential of useful organic compounds. Polymers having a low coefficient of friction, good pressure characteristics, good flexibility characteristics, high abrasion resistance, and good hardness are especially suitable. PTFE stands out among these. The surface of a polymer layer of this kind then forms the working surface of one of the sliding or rolling counterparts.

Moreover, given the application of a plurality of materials, the respective specific characteristics such as passivation, abrasion resistance, pressure resistance, good sliding ability, layer thickness, number of layers, and so on, can be set specifically and individually. Due to contact of a polymer layer with an uncoated surface, the specific characteristics of the respective polymer are transferred with the transfer of portions of the polymer to the previously uncoated side of the counterpart. Besides this, the shape of the object to be coated has no relevance in relation to the coating, and it is also advantageous that these polymer layers form a flat homogeneous surface suitable as a sliding or rolling surface.

When the substrate is metallic, there is the advantage that the surface hardness can be set specifically. The surface hardness of the coated part can then be reduced.

If, moreover, other functional layers are provided in the coating, the specific properties of diverse functional layers can be combined. If, for instance, one of the layers has a pressure resisting effect in that it causes pressure peaks that influence the coating to be distributed throughout the layers, there is an improvement in the structural strength and useful life of the relevant component and thus of the instrument as a whole.

The coating advantageously has internal attenuating means for reduction of the running noise.

When the electrical resistance of the coating changes due to wear, the qualitative and quantitative wear condition of the coating can be determined by measuring a change in resistance as caused by a reduction in the layer thickness, due, eg, to abrasion. When the coating is an electrical insulator, it is possible to determine whether the subassemblies are galvanically isolated by measuring the resistance, provided sufficient insulating coating still exists.

When the coating is visually distinguishable from the substrate, there is the advantage that the wear condition is detectable based on a visually perceptible change of the coating.

When the optical properties such as color, gloss level (mirror effect), or luminosity of the coating change due to wear and tear, there is the advantage that, depending on the site of wear, the degree of wear will be apparent from visually perceptible changes in the coating, eg traces of scoring.

When the coating reduces the surface hardness owing to the use of a polymer layer, it has an attenuating effect, which has a beneficial effect on running smoothness. But if a polymer layer is used and the coating produces no change in the surface hardness, the polymer layer then serves to reduce the friction resistance. If the surface hardness is increased, however, the erosion rate of the coating is reduced, which helps reduce the amount of vagrant attrition sources in the hand instrument. An advantage common to all of these variants is that the coatings can be varied to adjust the running characteristics, abrasion characteristics, and other properties.

It is advantageous when at least one component of an antifriction bearing or plain bearing or at least one sliding counterpart and/or contacting counterpart in the overall system is provided with an appropriate coating, so that lubrication is ensured. For instance, in the case of a ball bearing, the inner race and/or outer race and/or the ball cage and/or the balls can be coated. If only one of the moving parts is coated, the production costs can be reduced, and it is possible to provide an especially thin overall functional layer due to the transfer of material to the uncoated part. If an additional first unbound lubricant—this corresponds to a second lubricating material—such as grease or oil or an additive having a comparable effect is provided only on the contacting surfaces of the parts, an additional lubricating effect can be achieved which gives rise to the associated advantages such as improvement of the running smoothness. In the case of such a combination of lubricating materials, the behavior of the overall system can be set to meet a wide range of user requirements.

If the additional unbound lubricant exhibits high adhesion and cohesion forces, it will be prevented from migrating from the additionally lubricated surfaces and straying within the hand instrument or the working region of the tool, the adhesion forces being mainly contributory to the bond between two materials, whereas cohesion forces contribute to the internal coherence of the substance. If both have a high value, there is the assurance that the effect of the lubricant can unfold with pinpoint accuracy. In particular, there is the guarantee that said lubricant need to be applied only once, during production, and never again during the useful life of the product.

If an additional unbound second lubricant, which corresponds to a third lubricating material, is then applied in addition to the additional first lubricant already added, for instance if oil is added in addition to grease on the tooth flank or in the bearing, it is possible to adjust the operating behavior by way of additional parameters. For instance, the friction, and thus the operating temperature, can be further reduced, and the running smoothness can be further increased.

If the bound lubricant is designed as a carrier for the additional unbound lubricant, interaction of the enhancing characteristics of the respective substances can be ensured.

It is especially advantageous when the coating is sterilizable and/or when the additional lubricating material(s) are sterilizable. That way, the germ-free condition required in the medical sector can be achieved by sterilization.

When the lubricating substance of the coating and the additional lubricant are chosen so that they are compatible with a lubricant of the prior art, normal maintenance and lubrication with oil would not lead to a loss of the characteristics of the coating.

If the lubricating substance consists of a plurality of layers, a sliding and lubricating effect between the layers of the lubricating substance is also enabled, and this increases the lubricity.

### BRIEF DESCRIPTION OF THE DRAWINGS

Exemplifying embodiments of the invention are illustrated in the drawings, in which:

FIG. 1 shows a longitudinal section through a head housing of a dental turbine,

FIG. 2 is a partial longitudinal section of a dental hand instrument containing shaft and gears,

FIG. 3 illustrates the spatial configuration of a multifunctional hybrid layer,

FIGS. 4a and 4b are sections taken through bearings constructed in accordance with the invention,

FIG. 5 shows a coupling for connecting a hand instrument to a drive unit.

### EXEMPLARY EMBODIMENT

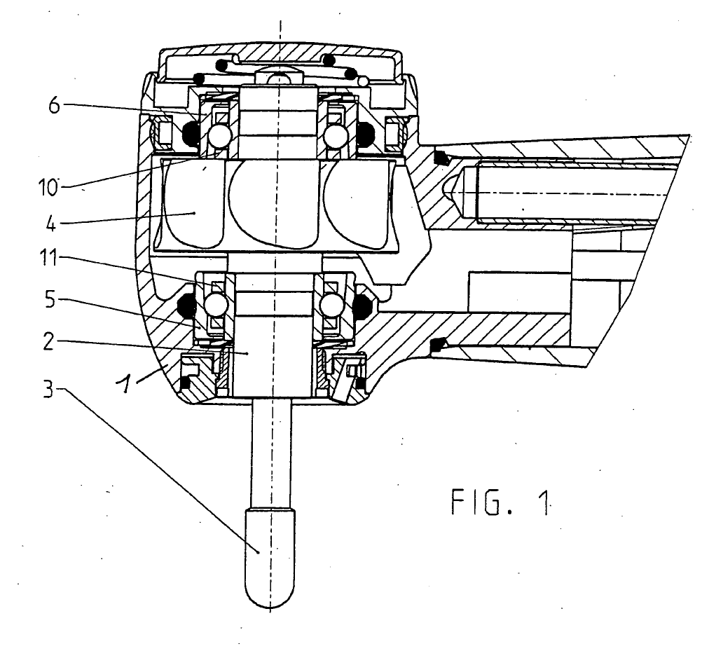

FIG. 1 illustrates the front part of a dental hand instrument. The drawing is a sectional view of the front part of a handpiece of a dental turbine having a head housing 1, in which a rotor shaft 2 having a rotor 4 for driving a tool 3 is mounted in antifriction bearings 5, 6. The rolling elements, in this case balls, are spaced by means of a ball cage 10, 11.

In this turbine handpiece, bearings 5, 6 and/or cages 10, 11 are possible candidates for coating.

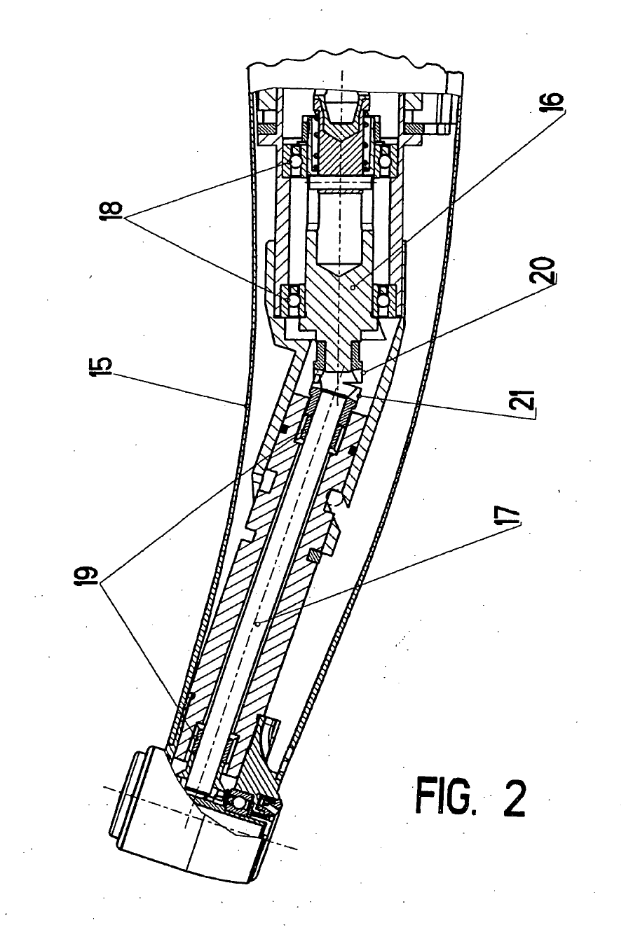

FIG. 2 shows a cutout of a dental handpiece in which two transmission shaft sections 16, 17 are mounted inside a handgrip 15. The shafts are mounted in a plurality of at least partially coated antifriction bearings 18, here in the form of ball bearings 18 and plain bearings 19. The gearing consists of two at least partially coated, meshing toothed wheels 20, 21.

The at least partially coated ball bearings 18 and plain bearings 19, and the at least partially coated toothing of the gearwheels 20, 21 can be lubricated with an additional lubricant. The ball bearings can be replaced entirely by plain bearings, in which case an appropriate coating can be provided.

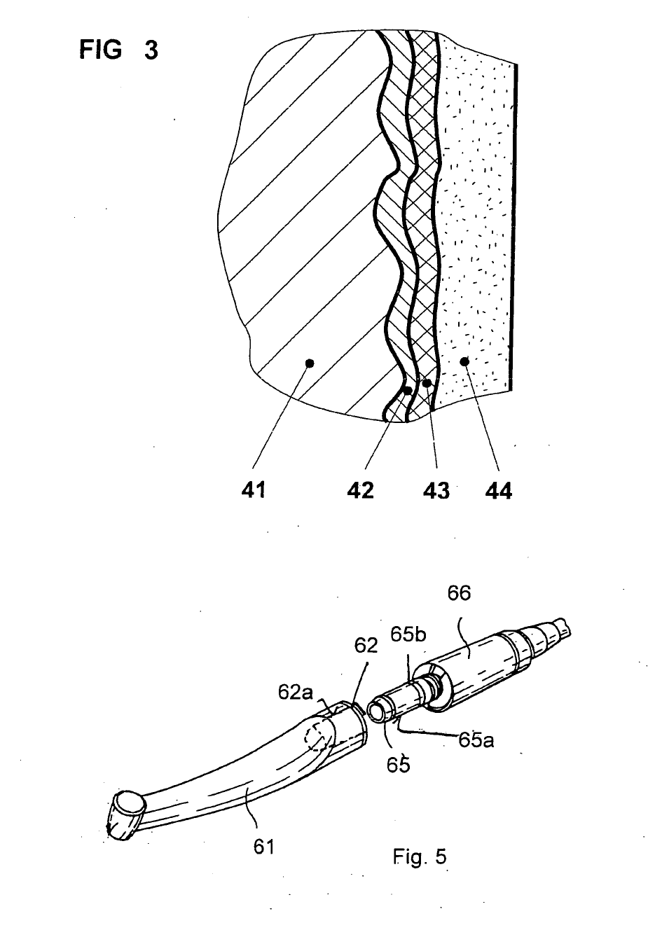

The at least partially coated gearwheels 20 and 21 mesh and require lubrication. The spatial configuration of a multifunctional hybrid polymer layer is illustrated in FIG. 3 as a first variant of the configuration of a coating.

A passivation layer 42 is applied to the surface of the substrate 41. On top of that there is a pressure-resistant layer 43, onto which a polymer layer 44 is applied to form the functional layer. The layer thickness is exaggerated in the drawing, the overall layer thickness being from 1 to 10 μm.

The advantage of a hybrid polymer layer is that each layer can fulfill a specific function such as passivation, abrasion resistance, pressure resistance, good sliding capability, and so on. Here again, the coating is independent of the shape of the coated object, and the layer thickness and number of layers can be set individually. The polymers form flat, homogeneous surfaces.

In its own internal structure, the polymer layer can consist of various sublayers of the same material. These sublayers can ideally assist lubrication through sliding processes between said sublayers. A lubricating substance bound in the polymer can also be embedded, and, in addition, unbound lubricating material can be applied, for example during assembly. The lubricity can be accurately controlled by way of the interaction between the individual layers.

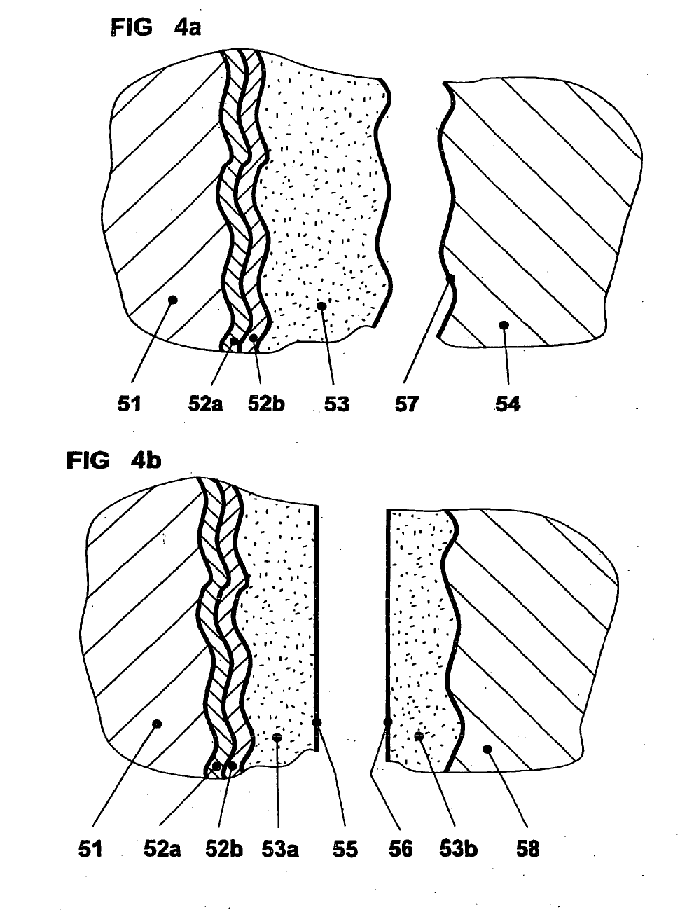

FIG. 4a illustrates a substrate 51 which is provided with a transition layer 52a and a support layer 52b, on which a functional layer 53 that contains or forms the lubricating substance is applied. Transition layer 52a forms a coupling layer on substrate 51 and support layer 52b enables pressure equalization. Alternatively, only one layer or more than two layers 52a, 52b can be used. Neither a carrier layer nor a functional layer is applied to the element 54 situated opposite functional layer 53.

The rolling process and the attendant processes generate changes in the distribution of the coating, as shown in FIG. 4b. With the rolling process, material is transferred from functional layer 53 to the opposing element 58 and settles there as functional layer 53b. Rolling surfaces 55, 56, which are smoothed on both sides, adapt to functional layer 53a on substrate 51 and functional layer 53b respectively.

Functional layer 53 can be a metal-doped DLC layer. These layers, which serve to afford resistance to wear, for example, prevent contact between the immediate rolling counterparts, namely substrates 51, 54. The characteristics of the overall functional layer can be individually varied by varying its layers, for instance the individual layers 52a and 52b. In the case of a first variant, the functional layer 53 has a coefficient of friction of 0.03.

Furthermore, functional layer 53 forming the lubricant layer, in this case the dry lubricant layer, exhibits the features of consisting of modified tungsten disulfide in lamellar form and of forming a molecular bond with, and consequently being physically attached to, the substrate. As a result, a protective layer is ultimately provided along the entire rolling path, such layer being non-toxic and non-corrosive and, above all, compatible with oils, fats, solvents, gasoline, and alcohol.

In a second examined embodiment, also known as WC/C, of such a surface coating having a metal-doped DLC layer, the layer used is a hard material layer having dry lubricating properties and a hardness of approx. 1,000 HV. The layer configuration includes a chromium intermediate layer and a plurality of WC/C layers in a lamellar configuration. All in all, the layers exhibit a good cohesion characteristic. Furthermore, for an overall layer thickness of from 1 to 4 μm, the adhesion characteristic is very good. Such a layer has a temperature resistance of 300° C. and a theoretical coefficient of friction of 0.2, given a uniformly smooth surface structure.

Depending on initial settings, the sliding plane of the lubrication means can be defined by the bound lubricating substance or by the unbound lubricant.

The functional layer of FIGS. 3, 4a, 4b is referred to herein as a “lubricating substance”, although, as described above, it can consist of very hard layers. What is critical is that the characteristics typical of lubrication, especially wear reduction in the present case, are achieved on the moving parts by means of the functional layer. Hence the use of the term “lubrication” to indicate the transfer of individual particles from one layer and the accumulation of these particles as a layer or partial layer on the other part.

FIG. 5 shows a dental hand instrument 61 having a coupling point 62 and a drive 66 having a mating coupling point 65. The points of contact 62a and 65a are coated as part of an overall lubrication-free concept. Any necessary retaining or fastening elements 65b can be likewise coated to increase useful life.

A very important aspect of the present invention is that only currently existing power-transmitting components are utilized for supplying the lubricating substance, without any need for additional components. Also, the surface that is provided with the coating is always a working surface that is subjected to stress, such as the inner race, the outer race, and/or the cage of a ball bearing, the shaft or bush of a plain bearing, or the tooth flanks of a gearwheel. This working surface forms to some degree a guide for a single adjacent component. A rolling element, on the other hand, makes contact with several components, namely the inner race, the outer race, and potentially a cage, and therefore has more than one working surface.

The guidance characteristic of the part donating the lubricating substance is not impaired in any real sense by the transfer of the lubricating substance. This is particularly so when the coating that releases the lubricating substance is not more than 10 μm thick and is preferably between 1 and 4 μm thick.

1-30. (canceled)

31. A dental hand instrument having parts that are moved relative to each other while in surface contact with each other, and also having a lubricating material for lubrication of said parts, at least one of said parts being coated over at least part of its surface (52, 53) with a lubricating substance, said lubricating substance being designed such that it is transferred from the part carrying said coating to the uncoated part when said parts are in motion and the lubricating substance and a mating surface (57) of the uncoated part (54) are such that the lubricating substance adheres to the mating surface of the uncoated part (54) and said lubricating substance in the coating (53, 44) is a solid lubricating substance.

32. A dental hand instrument as defined in claim 31, including a plurality of groups of parts that are moved relative to each other and require lubrication and for all groups of parts that are moved relative to each other, at least one of the parts has a coating capable of transferring lubricating substance, while different groups may optionally have different coatings.

33. A dental hand instrument as defined in claim 31, wherein the composition of said coating (52a, 52b, 53, 42, 43, 44) varies from its side adjacent the component to be coated toward its exposed surface.

34. A dental hand instrument as defined in claim 31, wherein the proportion of lubricating substance on the exposed surface of said coating (55) is greater than on the side adjacent the component to be coated.

35. A dental hand instrument as defined in claim 31, wherein said coating comprises at least one carrier layer (52a, 42) attached to the surface of the coated part and at least one layer of lubricating substance (53, 43, 44).

36. A dental hand instrument as defined in claim 31, wherein said lubricating substance in said coating (53, 44) has embedded components which assume a liquid state during operation.

37. A dental hand instrument as defined in claim 31, wherein said coating (53, 44) comprises a metal-doped, diamond-like carbon (DLC) layer.

38. A dental hand instrument as defined in claim 31, wherein said coating comprises a polymer layer consisting of one or more sublayers (42, 43, 44).

39. A dental hand instrument as defined in claim 31, wherein said carrier layer (42, 52a) is metallic.

40. A dental had instrument as defined in claim 31, wherein in the overall coating there are present further functional layers (52a, 52b, 42, 43), of which one is pressure-resistant.

41. A dental hand instrument as defined in claim 31, wherein one or more layers of said coating have internal attenuation means.

42. A dental hand instrument has defined in claim 31, wherein the electrical resistance of said coating varies with wear.

43. A dental hand instrument as defined in claim 31, wherein one of a plurality of layers has an electrically insulating effect.

44. A dental hand instrument has defined in claim 31, wherein said coating differs optically from the carrier material (51, 41).

45. A dental hand instrument as defined in claim 44, wherein the optical properties of said coating change with wear.

46. A dental hand instrument as defined in claim 31, wherein said coating reduces the surface hardness or leaves it unchanged.

47. A dental hand instrument as defined in claim 31, wherein at least one component of an antifriction bearing is provided with a coating as defined.

48. A dental hand instrument as defined in claim 31, wherein at least one component of a plain bearing is provided with a coating as defined.

49. A dental hand instrument as defined in claim 31, wherein for power transmission elements, at least one sliding component and/or touching component and/or contacting component is provided with a coating as defined.

50. A dental hand instrument as defined in claim 31, wherein the components that are moved relative to each other provide coupling or gear-shift functions.

51. A dental hand instrument as defined in claim 31, wherein an additional lubricant is provided exclusively on those surfaces of parts which contact each other.

52. A dental hand instrument as defined in claim 51, wherein said additional lubricant exhibits high adhesion and cohesion forces.

53. A dental hand instrument as defined in claim 51, wherein a second non-bonded lubricant is present.

54. A dental hand instrument as defined in claim 1, wherein the lubricating substance is in the form of a support for the lubricant or lubricants.

55. A dental hand instrument as defined in claim 31, wherein said coating and/or said other lubricants are sterilizable.

56. A dental hand instrument as defined in claim 31, wherein the lubricating material in said coating (53, 44) and/or said other lubricants are selected such that they are compatible with a lubricant of the prior art.

57. A dental hand instrument as defined in claim 31, wherein said lubricating substance comprises a plurality of layers.
